(19) United States
(12) Patent Application Publication
(10) Pub. No.: US 2026/0229521 A1
(43) Pub. Date: Aug. 6, 2026

(54) AQUEOUS METAL BATTERIES WITH POLYANILINE-CONTAINING CATHODES

(71) Applicant: The Texas A&M University System, College Station, TX (US)

(72) Inventors: Choongho Yu, College Station, TX (US); Md Zahidul Islam, College Station, TX (US); Yufan Zhang, College Station, TX (US)

(73) Assignee: The Texas A&M University System, College Station, TX (US)

(21) Appl. No.: 19/152,926

(22) PCT Filed: Jan. 31, 2024
(86) PCT No.: PCT/US2024/013847

§ 371 Date: Jul. 31, 2025

Related U.S. Application Data
(60) Provisional application No. 63/442,640, filed on Feb. 1, 2023.

(51) Int. Cl. H01M 4/60; H01M 4/02; H01M 4/62; H01M 10/36; H01M 50/414; H01M 50/429; H01M 50/463

(52) U.S. Cl. CPC H01M 4/606; H01M 4/625; H01M 10/36; H01M 50/414; H01M 50/4295; H01M 50/463; H01M 2004/028; H01M 2300/0005

(57) ABSTRACT

An embodiment of the invention is directed to a battery comprising: an anode; a carbon cathode with a polyaniline (PANI) deposition; and an aqueous electrolyte solution. An embodiment of the invention is directed to Fe-ion batteries comprising carbon nanotube cathodes having a PANI deposition and Fe metal anodes. Another embodiment of the invention is directed to Zn-ion batteries comprising carbon nanotube cathodes having a PANI deposition and Zn metal anodes.

WO

### CROSS-REFERENCE TO RELATED APPLICATION(S)

This application claims priority to U.S. Patent Application No. 63/442,640 filed Feb. 1, 2023, which is fully incorporated by reference as if set forth herein.

### TECHNICAL FIELD

The present disclosure relates generally to aqueous metal batteries and more particularly, but not by way of limitation, to aqueous metal batteries enabled by composite electrodes made of three-dimensional (3D) graphitic carbon and polymers.

### BACKGROUND

This section provides background information to facilitate a better understanding of the various aspects of the disclosure. It should be understood that the statements in this section of this document are to be read in this light, and not as admissions of prior art.

Current energy storage systems (EES) have various limitations. For example, some limitations can include: (1) fire hazards (typically, Li-ion batteries are utilized for EES); (2) high price of rechargeable Li-ion batteries (expensive and/or rare earth raw materials including lithium, cobalt, etc.); (3) short cycle life (the cycling life of Li-ion batteries are limited (typically 1,000-2,000 cycles at most); and (4) complicated manufacturing process. Additionally, (1) conventional systems employ additional systems for extinguishing fires; (2) drawbacks limit the size of conventional ESS; and (3) mass-produced raw materials used in conventional Li-ion batteries reduce their cost. However, the cost of Li-ion batteries are still higher than the cost of Fe and Zn batteries.

Global warming from anthropogenic activity has increased by around 1.0° C. above the pre-industrial levels, and if current emission rates continue, this warming will probably reach 1.5° C. between 2030 and 2052. To address the effects of rising temperatures, including extreme weather, rising sea levels, and ecosystem damage, the Paris Agreement was established which aimed to keep global warming to no more than 1.5° C. by reaching net zero emissions by 2050. Being the source of 75% of greenhouse gas emissions, the energy sector holds the key to preventing the worst effects of climate change. To reach net zero by 2050, 90% of the solution will involve renewable energy through direct supply, electrification, energy efficiency, green hydrogen, and biomass with carbon capture and storage. Due to the inherent uncertainty with renewable energy sources, advanced batteries for stationary energy storage systems will make a vital contribution to reaching the net zero emission target. So, it is of paramount importance to develop low-cost, safe, and large-scale energy storage systems. Even though the secondary battery market is dominated by Lithium-ion batteries (LiB), it is not a viable option when it comes to stationary energy storage systems due to the scarcity and cost of the lithium metal, and fire risk from the organic electrolytes used in LiB. Aqueous zinc-ion batteries (ZIBs) are becoming promising and attractive viable solutions for large-scale stationary energy storage systems in the post-LIB era due to zinc's low redox potential (−0.763 V vs. standard hydrogen electrode (SHE), high theoretical capacity (819 mAh/g, 5855 mAh/cm³), and abundant presence (75 parts per million in the earth's crust). In addition, aqueous electrolytes' substantial ion conductivity (1 S/cm) and nonflammability are additional factors that add to their allure.

Since the development of the rechargeable ZIBs with MnO₂, numerous studies have been carried out on Mn-based cathodes due to the abundance and low cost of the materials, multiple oxidation states enabling reversible redox reactions for zinc ion storage, reasonable working voltage, high capacity. In addition, abundant crystal structure of MnO₂ such as α, β, γ,δ and others allows for a range of electrochemical behaviors, enabling tailored performance to meet specific requirements, such as high capacity or fast charging. Vanadium-based oxide is another most used categories cathode material used for ZIBs due to their high discharge capacity, multiple redox states, tunable properties, and abundance. Initially V₂O₅ was primarily used as the cathode, but after the introduction of pillared layered V₂O₅, numerous works were done on the pillared V₂O₅ cathodes. Although the discharge capacity for Vanadium-based cathodes is higher than the Mn-based cathodes, their working voltage is low. Vanadium phosphate has been used to increase the working voltage that shows a voltage of 1.7V compared to the traditional 0.6-0.8V of Vanadium-based cathodes. Other than the Mn, and Vanadium, cobalt oxides, Prussian blue analogues (PBAs) and layered sulfides were also used as the cathodes. Although PBA shows promise in terms of voltage, they are noncompetitive in terms of discharge capacity. Recently, interests are growing in organic cathode materials for ZIBs. This interest stems from the fact that organic materials offer high theoretical capacity, wide range of tunable properties through molecular design, abundance and sustainability, and chemical diversity. Some of the organic materials that are explored in ZIBs are mainly conjugated carbonyl compounds and organic conductive polymer.

Aiming to improve zinc-ion battery cathodes, recent studies have demonstrated remarkable stability and cycle life at high charge-discharge rates. Some of the highest cycling reported are 5000 cycles for polymer strengthened MnO₂ cathode with a capacity of 125 mAh/g at 2 A/g, 6000 cycles at 3 A/g for K-birnessite on mesoporous carbon cathode, 5000 cycles for Co₃O₄ cathode at 4 A/g (Ma et al., 2018), 4000 cycles for LiV₂(PO4)₃ at 10° C., 10000 cycles at 10° C. for organic polymer. Though impressive, these results raise important questions about how applicable they are to stationary energy storage systems. A different approach is required for stationary applications due to their operational demands; this approach should be in line with low C-rate (1C, C/2, C/4) cycling for continuous and extended energy delivery. In addition, self-discharge behavior should also be analyzed upon resting which is also missing in the literature.

Additionally, although Fe-ion batteries are rarely studied, iron shows great potential for low-cost energy storage due to its absolute price advantage ($60/ton) compared with zinc ($2600/ton) and its high theoretical capacity of 960 mAh g⁻¹ and 7557 mAh cm⁻³, which can be a game-changer for stationary energy storage.

In the last several years, certain cathode materials have been utilized in Fe-ion batteries. A Prussian blue analog (PBA) has been investigated as cathode material in Fe-ion batteries exhibiting 1000 cycles with 80% capacity retention, and has been used to study Fe-sulfur batteries without polysulfide shuttling, where the cycle number could reach 150. Other studies have demonstrated that Fe ion bolted on VOPO₄ cathode whose capacity is 100 mAh/g, and 68% capacity, faded after 800 cycles. However, for stationary energy storage, a 3000-4000 cycle life (one cycle per day for 10 years) is needed and these cathode materials are unable to meet this requirement.

Organic cathode materials have been applied in Li-ion batteries, Sodium-ion batteries, Potassium-ion batteries, and ZIBs. However, there are no reports of the use of organic cathodes in Fe-ion batteries. Organic polymers have many advantages such as molecular-level controllability and structural diversity, and they also show higher resistance to losing from the electrode due to the tangle with the supporting carbon materials by their long molecule chain, thus low capacity fading.

Studies investigating polyaniline (PANI) as cathode material in ZIB shows 92% capacity retention after 3000 cycles, and validate the Zn ions insertion/extraction mechanism by ex-situ XPS and supercapacitor-liked dual-ion mechanism to promote the operating voltage, capacity, and long cycle life. The greater positive redox potential of Fe/Fe²⁺ (−0.44 V, vs. SHE) relative to Zn/Zn²⁺ (−0.76 V, vs. SHE) makes it a good candidate for the use of PANI as a cathode material in a Fe-ion battery, because the greater redox potential avoids the water split voltage window during the charge process (>1.23 V) relative to a Zn/PANI battery (typically charge to 1.5 V), thereby resulting in better stability in electrolyte for long cycle life.

### SUMMARY OF THE INVENTION

An embodiment of the invention is directed to a battery comprising: an anode; a carbon nanotube cathode with a polyaniline (PANI) deposition; and an aqueous electrolyte solution. An embodiment of the invention is directed to Fe-ion batteries comprising carbon nanotube cathodes containing a PANI deposition and an iron anode. A further embodiment of the invention is directed to Zn-ion batteries comprising carbon nanotube cathodes containing a PANI deposition and a zinc anode.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1A shows the preparation of a sandwich-type cathode; FIG. 1B shows a schematic of a PANI cathode in Fe-ion batteries during the charge and discharge process; and FIG. 1C shows an FTIR-ATR of graphite and PANI (commercial product and synthesis by electrical deposition method)

FIG. 2A shows the voltage profile of a Fe-ion battery with a PANI cathode at varying C rates; FIG. 2B shows the specific capacity and Coulumbic efficiency of Fe-ion battery with PANI cathode at varying C rates; and FIG. 2C shows the GCD cycle performance of Fe-ion battery with PANI cathode at 10 C rate.

FIG. 3A shows a CV curve of PANI/CNT electrode for different cycles; FIG. 3B shows a CV curve for different working electrode in different solution; FIG. 3C shows CV curves of PANI/CNT with varying scan rates; and FIG. 3D shows the corresponding Log (peak current) and Log (scan rate) for different redox peaks.

FIG. 4 shows X ray diffraction data for a pristine carbon steel anode from the coin cell without cycle, after 500 cycles and after 5000 cycles.

FIG. 5A shows a schematic of a cylinder cell; FIG. 5B shows the GCD cycle performance of the cylinder cell at 2 C rate; and FIG. 5C shows a schematic of the advantages of a Fe-ion battery with PANI cathode relative to lead-acid batteries and Li-ion batteries.

FIG. 6 shows the charge and discharge of a ZIB cell in an electrolyte containing DMSO.

FIG. 7A shows the effect of current density on cycle life; FIG. 7B shows the effect of loading at 1C; FIG. 7C shows the ratability, and FIG. 7D shows the comparison of total energy throughput for the highest performing cathodes currently known.

FIG. 8 shows the cycling performance of a ZIB cell.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Current energy storage systems (EES) have various limitations. For example, some limitations can include: (1) safety from fire hazards (typically, Li-ion batteries are utilized for EES); (2) high price of rechargeable Li-ion batteries (expensive and/or rare earth raw materials including lithium, cobalt, etc.); (3) short cycle life (the cycling life of Li-ion batteries are limited (typically 1,000-2,000 cycles at most); and (4) complicated manufacturing process. Additionally, (1) conventional systems employ additional systems for extinguishing fires; (2) drawbacks limit the size of conventional ESS; and (3) mass-produced raw materials used in conventional Li-ion batteries reduce the cost but cannot be lower than low-cost Fe and Zn batteries.

Aqueous batteries can mitigate fire risks and the high price of Li-ion batteries. An embodiment of the invention is directed to a cylinder-type battery design for easy manufacture process. The batteries of the claimed invention can charge/discharge more than 20000 and 9000 cycles with 84% and 70% capacity retention respectively with low-cost Fe-ion and Zn-ion batteries using low-cost cellulose based separators. Complicated manufacturing processes associated with 2D electrodes in conventional batteries can be largely simplified by the 3D electrodes used herein.

A embodiment of the claimed invention is directed to a battery comprising an anode, a cathode comprising a carbon nanotube with a polyaniline (PANI) deposition and an aqueous electrolyte solution. In certain embodiments, the cathode comprises a sandwich-type cathode comprising carbon nanotubes sandwiching PANI. In other embodiments, the cathode comprises a PANI deposition on its surface.

The battery of the claimed invention can be constructed as a coin cell, cylindrical cell, pouch cell or prism-shape.

In certain embodiments the anode is in the form of a foil or a wire. In some embodiments, the anode comprises at least one of carbon steel, iron, zinc, manganese, nickel, cobalt, vanadium or titanium.

In an embodiment of the invention, the electrolyte solution of the battery comprises at least one of FeSO₄ or ZnSO₄.

In an embodiment of the invention, the battery comprises a separator. In certain embodiments, the separator comprises a braided sleeve, which in certain cases comprises polyester.

An embodiment of the invention is directed to Fe-ion batteries comprising polymer (polyaniline)-coated carbon nanotube cathodes and Fe metal anodes. Another embodiment of the invention is directed to a Zn metal anode to fabricate Zn-ion batteries. The batteries are preferably aqueous batteries, which mitigates any fire risk. Fe-ion batteries (coin cells) can operate more than 20,000 cycles where capacity retention is 84%. In addition, a Zn-ion battery can operate more than 9,000 cycles where capacity retention is 70%. These cycling performances are much greater and longer lasting than those of current commercial Li-ion batteries. Low cost FeSO₄ and ZnSO₄ can used as electrolytes for the Fe-ion and Zn-ion batteries, respectively. In certain embodiments, cylinder-type batteries are designed with a length similar to AA batteries, which simplifies battery manufacturing processes.

In an embodiment, PANI is electrodeposited on a 3D cylindrical carbon nanotube sponge and used as a cathode. The anodes are wire-type carbon steel and Zn metal wire respectively for the Fe-ion and Zn-ion batteries. The anode is wrapped with a separator and inserted into the center of a cylindrical cathode along the axial direction. Cellulose based separators enable long cycling performances (<1500 cycles) without capacity fading in contrast to those using glass fiber separators.

Reference will now be made to more specific embodiments of the present disclosure and data that provides support for such embodiments. However, it should be noted that the disclosure below is for illustrative purposes only and is not intended to limit the scope of the claimed subject matter in any way.

Iron-ion batteries have great potential for stationary energy storage due to their low cost and safety with an aqueous electrolyte. However, the reported cathode materials in Fe-ion batteries cannot achieve long-cycle performance. Therefore, the cost efficiency for those Fe-ion batteries couldn't achieve the commercialization requirement. Use of PANI as a cathode material in Fe-ion battery achieves 94%, 84% and 68% capacity retention after 10000, 20000 and 30000 cycles at 10 C rate. The mechanism that PANI stores Fe²⁺ ions is based on Fe—N covalent bonding formation. PANI exhibits 80 mAh/g capacity with Fe ions inserted and trapped. Carbon steel anode shows 99% plating/stripping efficiency in a full-cell test after 5000 cycles without corrosion issues. A 3D structure cylinder battery was designed to scale up the loading of PANI, and this easy and feasible method simplifies the manufacturing process of the battery.

The use of PANI with 150 mAh/g theoretical capacity as cathode material in a Fe-ion battery demonstrates a cost-efficiency battery with a long cycle life. An embodiment of the invention is directed to a carbon steel anode and sandwich CNT/PANI/CNT cathode. This Fe-PANI battery delivers 80 mAh/g at 10 C and ~0.7 V discharge voltage. Also, our cell exhibits an excellent charge/discharge cycle performance that 94.7% capacity retention after 10000 cycles, 88% capacity retention after 20000 cycles and 68% capacity retention after 30000 cycles at 10 C rate. The mechanism of Fe ion storage in PANI is Fe—N covalent bonding formation, which was studied by experiment and simulation. Then, we design a 3D structure cylinder cell (similar size to an AA battery) with higher loading as a concept proof for an easy manufacture process to scale up. The battery shows a cost-efficiency, long cycle, safe and easy-manufacture cell as an example of stationary energy storage, and also promotes and enlightens the following research of renewable energy and its storage.

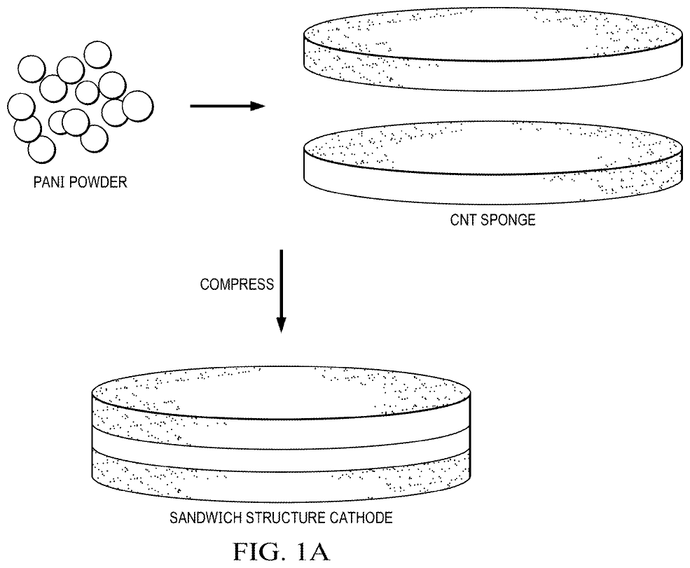

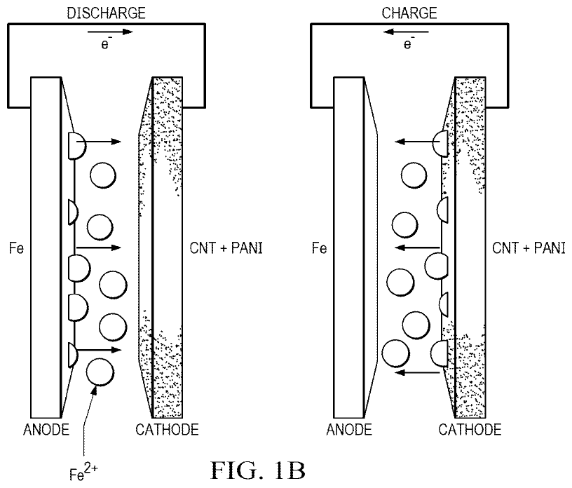

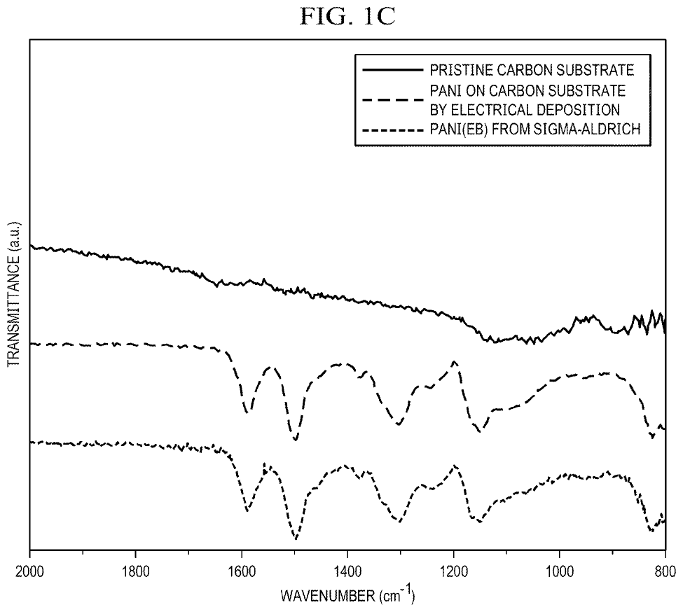

The Fe-ion battery of the present invention consists of low carbon steel as an anode and a sandwich-type PANI cathode with FeSO₄ aqueous electrolyte. In FIG. 1A, the sandwich-type cathode is made of two pieces of circular CNT sponges and compressive PANI powder in the middle. FIG. 1B shows the charge and discharge process of PANI cathode in a Fe-ion battery. Typically, PANI is loaded on the electrode by an electrical deposition method for supercapacitors and batteries. Compared with the PANI cathode formed by the electrical deposition method, the sandwich-type cathode has smaller voltage polarization, larger specific capacity, and more stable cycle performance. FIG. 1C shows that the two types of electrodes with the same PANI. In the sandwich-type electrode, PANI is bolted between two mesh-like CNT sponges, so the middle PANI stays in place and does not escape. PANI itself is a conductive material, which is one of the reasons that aggregated PANI in the sandwich-type cathode is unlike the non-conductive cathode material which requires uniform dispersion and high surface area to achieve larger capacity. For this conductive cathode material, the fastness of PANI is useful for long cyclability. A porous CNT sponge has the advantage of not only the conduction between PANI and current collector but also the contact between electrolyte and PANI for ions moving in and out. The fastened sandwich cathode structure contributes to the long-cycle performance of the cell, and the preparation process is simple and controllable. For the anode, carbon steel is used to replace the typical anodes which consist of Fe powder, conductive carbon material, and a polymer binder, due to their similar cell performance, price advantage and higher plating/stripping efficiency of carbon steel.

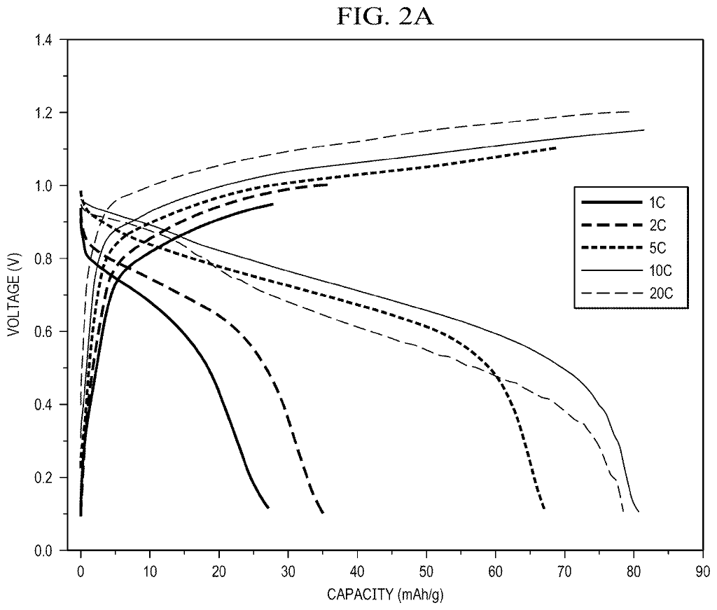

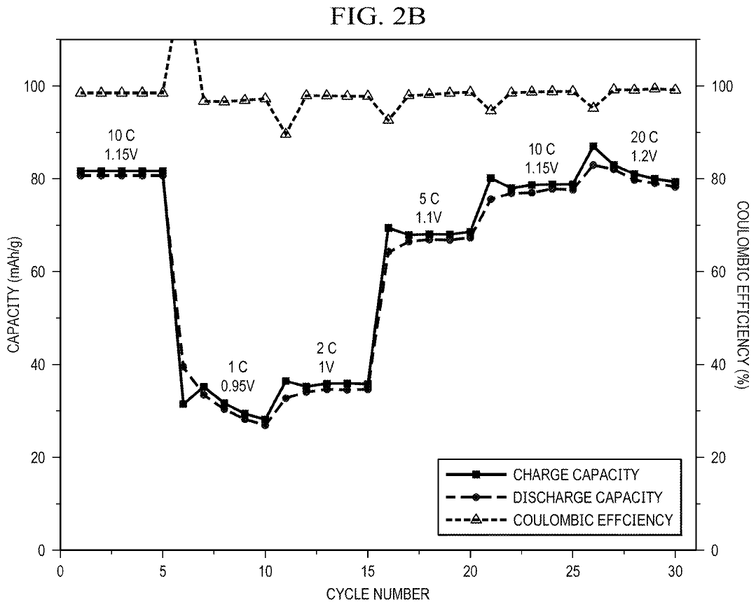

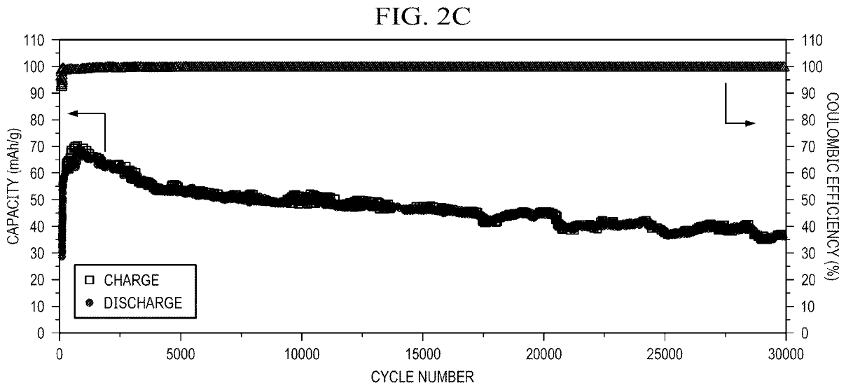

FIG. 2A shows the galvanostatic charge/discharge (GCD) profiles of PANI as cathode material in Fe-ion batteries at different C rates. According to the C rate, different voltages are set as charge end conditions due to the different voltage limitation when different currents are applied. For example, when the cell is charged at 1 C, the voltage decreases from 1.03 V. This voltage limitation is caused by the Fe²⁺/Fe³⁺ redox couple. Fe³⁺ ions oxidize to Fe3+ on the cathode side at high voltage conditions. A higher voltage limitation is observed with higher current density, and it may be caused by iron ions diffusion. To ensure high Coulumbic efficiency, the voltages were set as follows: 0.9 V at 1C, 1V at 2C, 1.1V at 5C, 1.15 V at 10 C, and 1.15 V at 20 C for our coin cell testing (FIG. 2B). Due to the different charging end voltage, the cell of the current invention does not show the highest capacity at low C rate like typical cells, since they are charged to the same voltage at different current density. By considering the voltage window of the water split (>1.23V), the inventive cell has an optimized performance at 10 C to 1.15V, which is 80 mAh/g specific capacity.

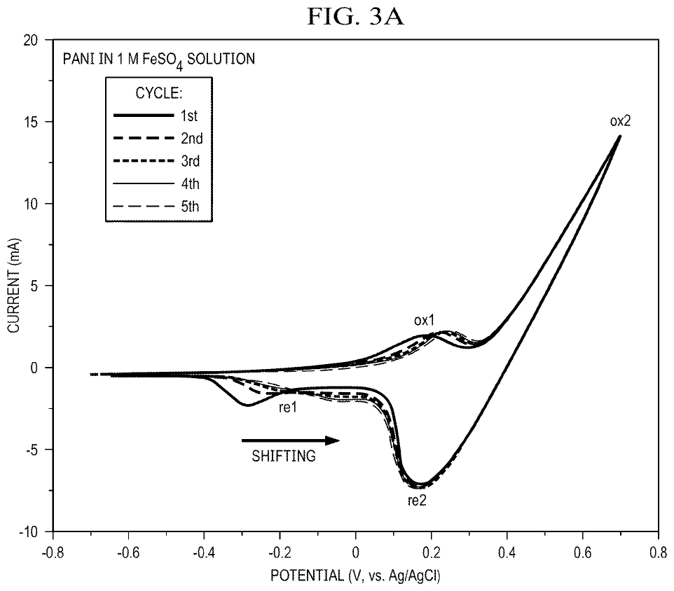

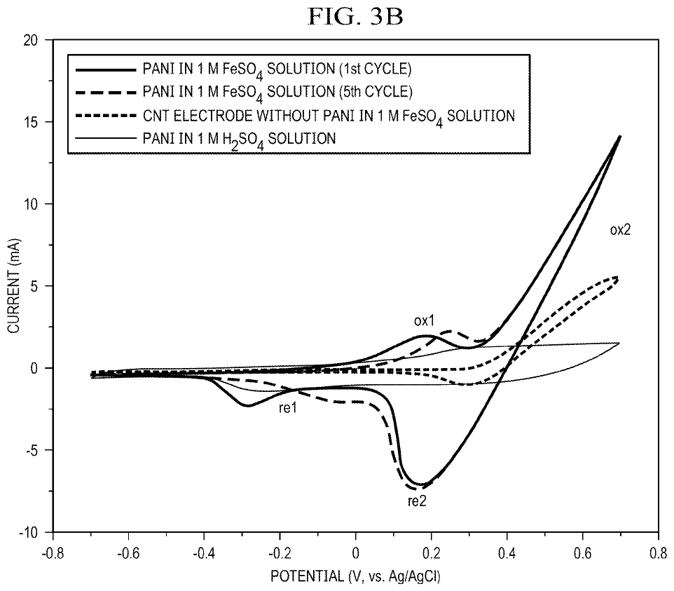

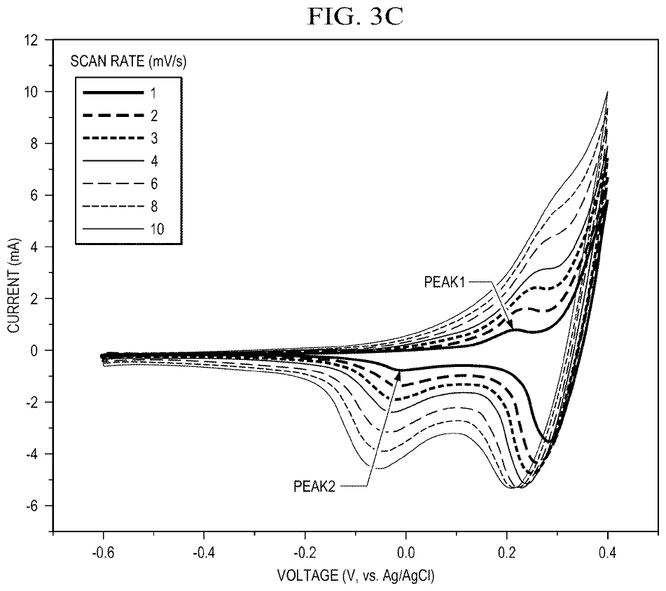

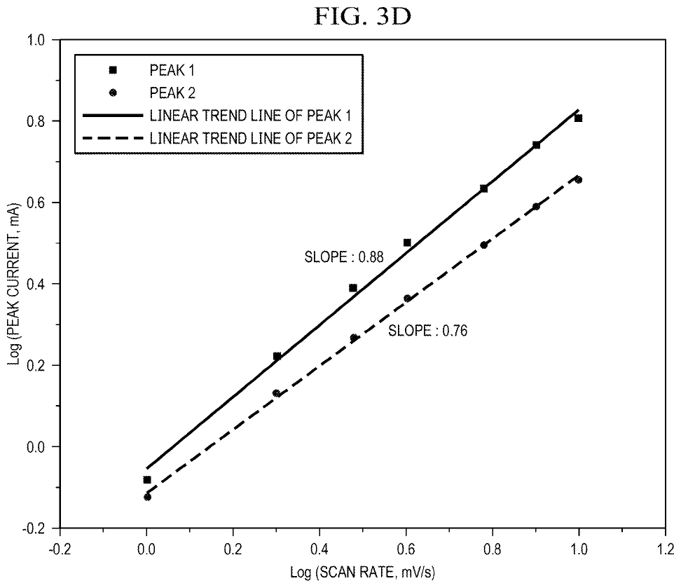

FIG. 2C shows the charge-discharge cycle curve of our Fe-PANI battery at a 10 C rate. The specific capacity after 100 cycles was selected as the initial specific capacity, which is 53.6 mAh/g. The specific capacity after 100 cycles is better than that of first cycle and the highest specific capacity as initial reference. The reason is that the specific capacity in the first cycle is only 30.0 mAh/g, which is too small capacity for the initial reference, and the highest specific capacity is at ~1000 cycles, which is too many cycles for initial reference. The present cell exhibits 98.7% capacity retention after 5000 cycles, 94.7% capacity retention after 10000 cycles, and 88.0% capacity retention after 20000 cycles. The specific capacity increase to 70.0 mAh/g after 800 cycles and the increase of the specific capacity in initial cycles may be due to the surface area and increase of active site during cycles. This high capacity retention indicates that PANI is well fastened in sandwich-type electrodes and the redox capability of PANI can maintain for exceptionally long cycles. It's worth mentioning that unlimited Fe was applied in this case (0.005-inch thickness carbon steel), so except for the anode, this system including the cathode, separator, and electrolyte has favorable stability. To identify the mechanism of Fe storage in PANI, the redox potential of PANI was measured in FeSO₄ solution. FIG. 3A shows the cyclic voltammetry (CV) curves for PANI on a CNT sponge electrode in 1M FeSO₄ solution. Peak ox1 has a slight shifting (0.07 V) to positive potential from the first cycle to the fifth cycle, whereas an obvious shifting (0.3 V) in peak rel. Different solutions and electrodes were used to confirm the redox species of those redox peaks in FIG. 3B. To be specific, peak ox2 and re2 were observed when CNT sponge without PANI electrical deposition is used as working electrodes in FeSO₄ solution, and these redox peaks are Fe²⁺/Fe³⁺ redox peaks. And only peak ox1 and re1 are shown when the CNT sponge with PANI electrical deposition is used as the working electrode in H₂SO₄ solution, so these redox peaks are PANI redox peaks. Peak re1 is the reduction peak of PANI, and the insertion of Fe ions during the PANI reduction process can increase ~0.3 V of the reduction potential, and the improvement of reduction potential indicates that the energy of PANI reduction change due to the Fe ions attachment. This reduction potential vs. Fe/Fe²⁺ is the discharge voltage of our Fe-ion battery with PANI cathode, so the shifting of this potential to a positive direction indicates higher output voltage and higher output energy.

The high-rate capability is further investigated by CV measurement as shown in FIG. 3C. The relationship between peak current and scan rate can be described as i=av^{b}, where i is the peak current; v is the scan rate; and a and b are adjustable parameters. The b value for the oxidation peak of CNT sponge/PANI is 0.88 (FIG. 3D) from 1 mV/s to 10 mV/s scan rate, which indicates that surface-controlled behavior dominates the charge process. The physical meaning of this surface-controlled behavior in PANI oxidation process is the Fe²⁺ ion adsorption from the bulk of electrolyte to the cathode surface, and this behavior is a fast-kinetic process. PANI oxidation is the charge reaction in the cathode for our Fe-ions battery, which explains the high-rate capability during the charge process. For the reduction of CNT sponge/PANI, the b value is 0.76, which demonstrates the combined mechanism of surface-controlled behavior and semi-infinite linear diffusion of the Fe²⁺ ions from the cathode to the electrolyte.

The shifting of PANI redox potential in FeSO₄ electrolyte indicates that Fe²⁺ ions participate in PANI redox process. To further investigate the interaction and location of Fe²⁺ in PANI, we simulated the PANI oxidation process.

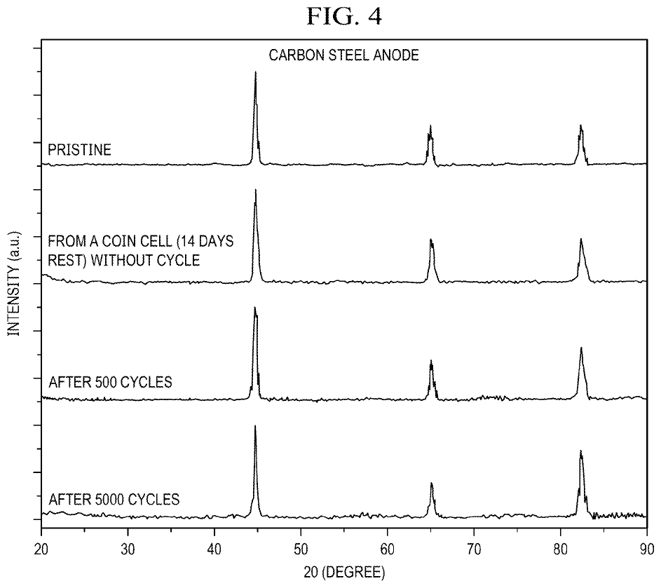

For the anode part, since there is no study about Fe plating/stripping process on carbon steel anode in Fe-ion batteries, the morphology and the stability of the Fe plating/stripping process on carbon steel anode was investigated. FIG. 4 shows X ray diffraction data for a pristine carbon steel anode from the coin cell without cycle, after 500 cycles and after 5000 cycles.

The typical process to identify the plating/stripping efficiency on a substrate is GCD test for a symmetric cell. However, the carbon steel substrate contains about 99% Fe; therefore, GCD measurement is not a reliable method to measure the plating/stripping efficiency.

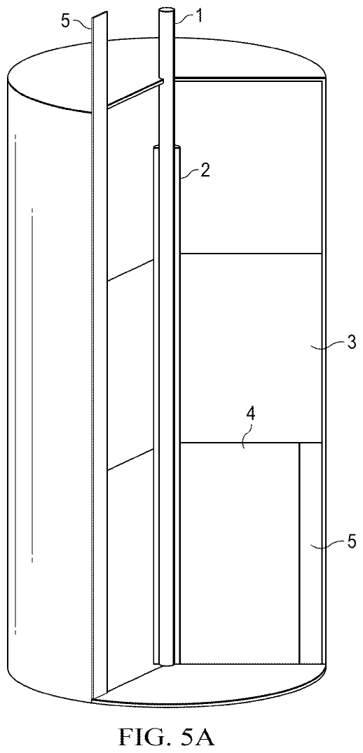

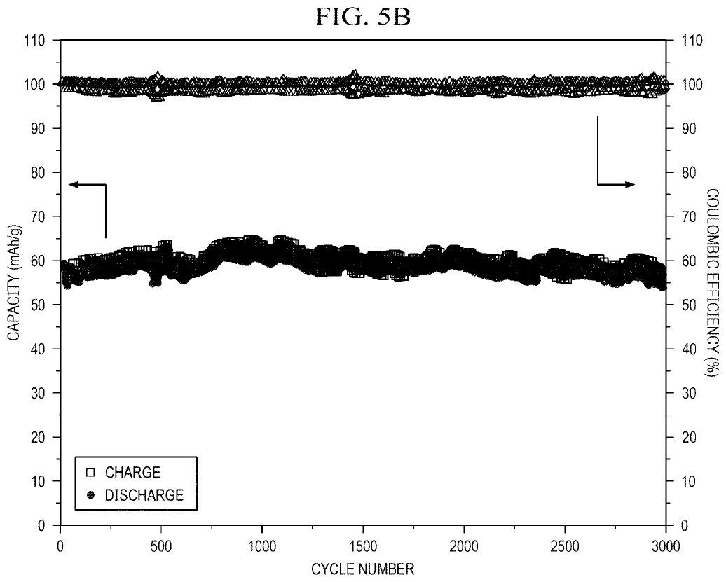

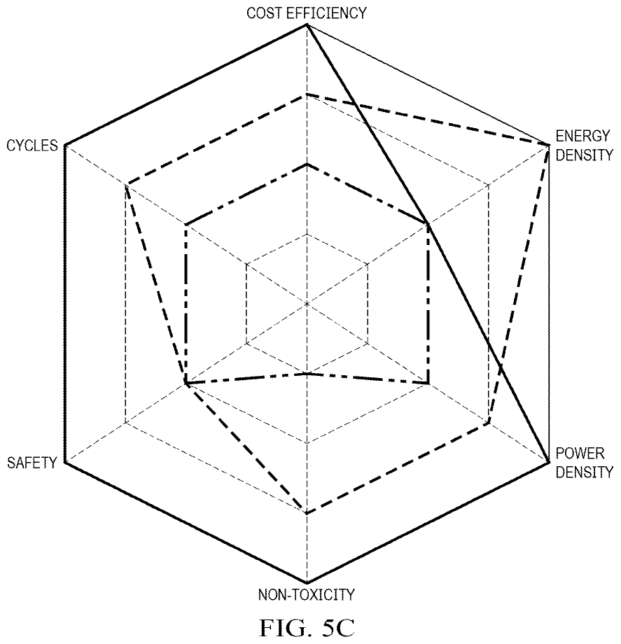

Due to the low loading in the coin cell, coin-cell performance cannot satisfy real world applications. To further investigate the scale-up performance of the PANI in Fe-ion battery, we designed a cylinder battery (FIG. 5A) with a similar dimension to the AA cell to scale up the loading of PANI to 50 mg. In FIG. 5A, the numbers represent the following components: 1. Anode (Carbon steel wire); 2. Separator (Braided sleeve. Made of polyester.); 3. Electrolyte (FeSO₄ solution); 4. Cathode material (CNT sponge with PANI deposition.); 5. Graphite foil for current collector. This design improves not only the loading of PANI, but also simplifies the manufacture process. The CNT sponge was synthesized and cut into a 1.5 cm height with 2.1 cm diameter cylinder. PANI was electrically deposited on the CNT sponge by a DC power supply with 50 mg loading. A carbon steel wire as an anode with a braided sleeve as a separator was plugged through the CNT sponge. A glass vial was used for the electrolyte container, which also provided the pressure between the anode and cathode by the compression of the CNT sponge. FIG. 5B shows the charge-discharge cycle curve of this cylinder cell at 2C and there is no capacity fading after 3000 cycles. This performance indicates our Fe-ion battery with PANI cathode is promising energy storage and prove that this concept has the potential to simplify the manufacturing process in the battery industry.

Compared with Li-ion batteries and lead-acid batteries, the Fe-PANI cell of the claimed invention shows many advantages in cycle life, cost efficiency, safety, non-toxicity, and power density, but not energy density (FIG. 5C). The battery is built with the lowest price components. For example, carbon steel is used as a Fe anode which is cheap and without supply chain issues. The mature chemical products FeSO₄·7H₂O as electrolyte is only 0.03$/kg and PANI is also only ~2.17 $/kg which may be reduced if its industry develops due to the demand increase. Because of the long cycle life and low-cost components in our battery, the cost efficiency ($ per kWh per cycle) of our battery is superior to that of Li-ion batteries and lead-acid batteries. Additionally, the use of aqueous electrolytes diminishes the fire hazard.

The use of electrodeposited PANI on carbon nanotubes (CNT) as a cathode material is useful in Zn-ion batteries as well. PANI, which is well-known for its adjustable characteristics, has inherent conductivity and redox activity. These properties are essential for effective charge transfer and reversible ion storage in ZIBs, particularly at low C-rates.

An embodiment is directed to a ZIB with PANI on 3D sponge-like interconnected CNT as the cathode, and ZnSO₄ electrolyte, to achieve a long cycle life at a practical current density suitable for stationary energy storage systems. In addition, self-discharge behavior is also analyzed for a prolonged period for the very first time to the best of our knowledge. The cell shows a remarkable 5928 cycles at a current density of 0.2 A/g, and 9000 cycles at 2 A/g with a retention of 70%. Moreover, self-discharge analysis also shows that, even with a prolonged rest period, the capacity loss is less than 10% and can recover fully when cycled normally. These remarkable performance stems from the unique interconnected 3D sponge-like CNT as the host for the PANI cathode that can maintain the structural integrity for long period of time, and the (Dimethyl sulfoxide) DMSO additive that suppresses the undesired water-induced side reactions and dendrites.

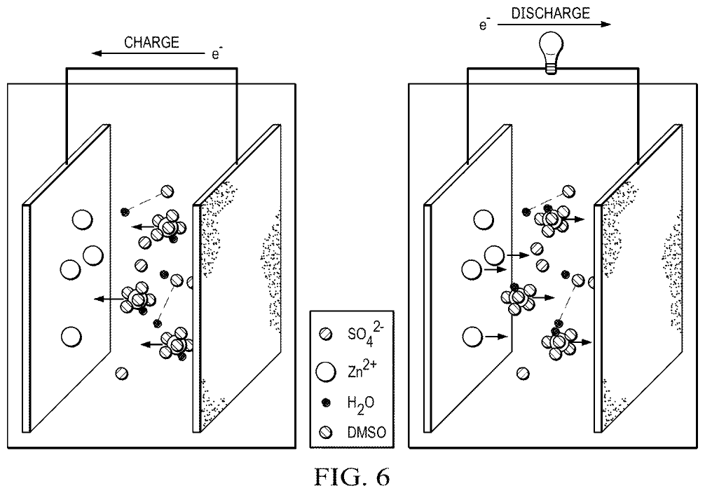

FIG. 6 shows the charge and discharge of the cell in the electrolyte containing DMSO. In the aqueous solution, each Zn²⁺ is solvated by six water molecules forming [Zn(H2O)6]2+ and this causes the H2 evolution reaction at the anode since water is unstable at the zinc deposition potential. Therefore, to address the parasitic H2 evolution reaction, the anode surface needs to be modified in a such a way that it increases the overpotential for H2 evolution reaction or modify the solvation structure of the zinc by replacing water molecules. The addition of the DMSO as an additive to the ZnSO4 electrolyte modifies the zinc solvation structure by replacing water molecules from the solvation structure. In addition, DMSO also bonds with the free water molecules. As a result, the overall water activity is reduced, and since there is not enough water molecules in the zinc solvation structure, the parasitic H2 evolution reaction is suppressed. This modification of the solvation structure and the electrolyte is possible since DMSO has a propensity to bond with highly polar water molecules due to its polar nature and hydrogen bonding capability. With DMSO, the new solvated structure with DMSO goes back and forth during the charge and discharge cycle.

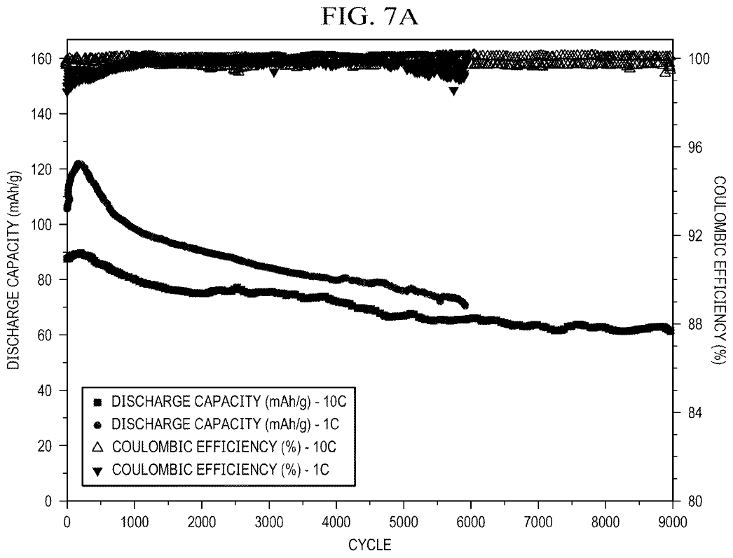

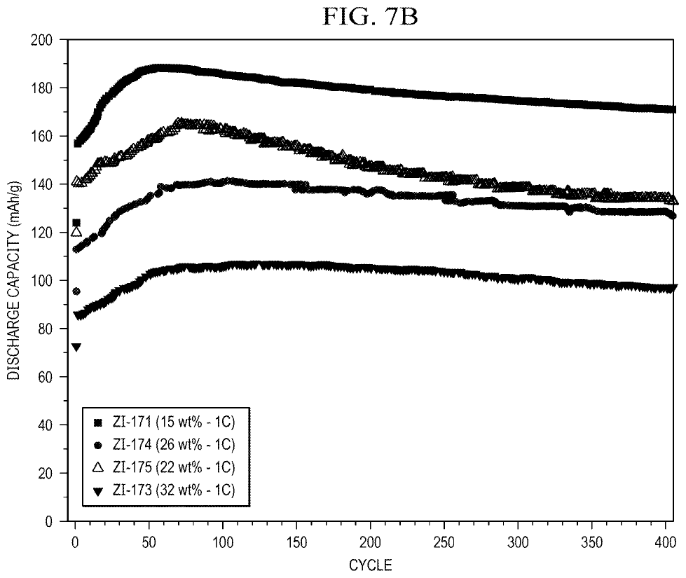

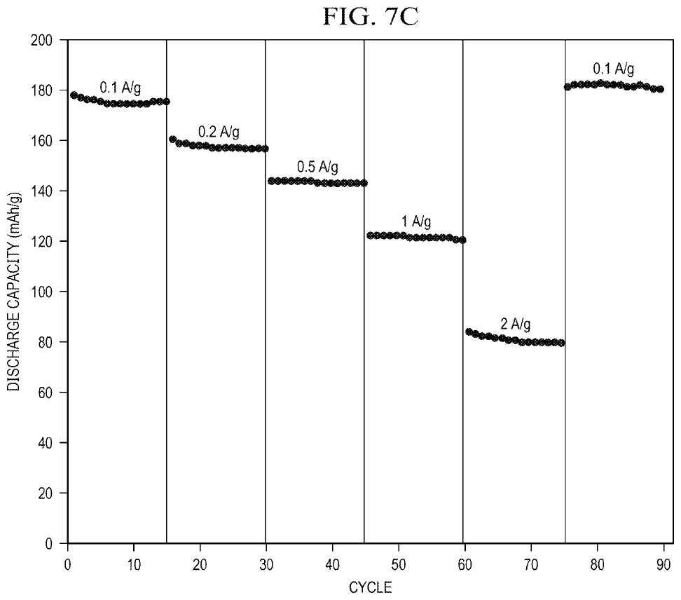

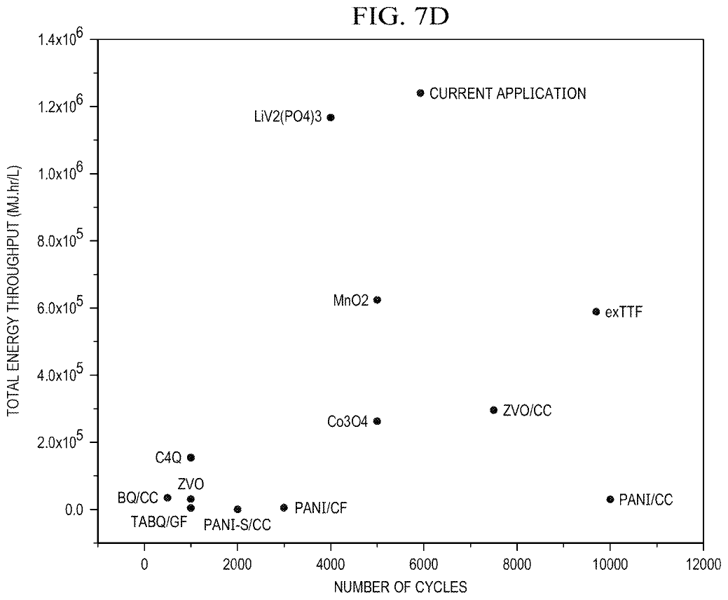

FIG. 7A shows the long cycling of the cell at 0.2 A/g and 2 A/g which are equivalent to 1 C and 10 C considering a capacity of 200 mAh/g for the PANI. The cells were stopped after they reached 70% of the initial capacity. The cell with 10 C lasts 9000 cycles and the cell with 1C survives 5928 cycles without failing and maintaining 70% of the initial capacity which is remarkable considering the current densities. For the cell with 1 C, the initial columbic efficiency (CE) was lower but upon cycling it increased close to 100%. For 10 C its CE is close to 100% from the beginning. In literature, long-term cycling at a practical or low c-rate is missing, since at a low c-rate the cell performance is plagued by the undesirable side reactions, cathode structural instability due to volume expansion, and dendrite formation. During the charge-discharge of the ZIBs, the volume expands and contracts which causes mechanical stress on the electrodes. Volume change induced mechanical stress leads to the structural degradation of the cathodes, cathode cracking, detachment of the active material. As a result, the cycling stability and capacity retention is decreased. The CNT host for the PANI in our cathode has highly porous with interconnected sponge-like framework can accommodate the volume changes during the cycling. Therefore, the structural integrity of the cathode over a long period of time is maintained. In addition, the modification of the zinc solvation structure with DMSO enables the uniform zinc plating and stripping and suppression of the parasitic H2 evolution reaction on the anode. As a result, the PANI/CNT cathode shows outstanding cycling of 5928 cycles even at a low current density of 0.2 A/g.

FIG. 7B shows the effect of PANI loading on the capacity. It is seen that the higher the loading the lower the capacity of the cathode. It is assumed that the higher loading of PANI results in blocking the pores which may cause the underutilization of the total active sites in PANI cathode. This can be improved by making the cathode film thinner so that the ion transportation is not hampered. FIG. 7C shows the ratability of the cell. The cell shows a capacity of 180, 162, 145, 122, and 85 mAh/g at a current density of 0.1, 0.2, 0.5, 1, and 2 A/g. The cell recovers the initial capacity when the initial current density is applied after 75 cycles.

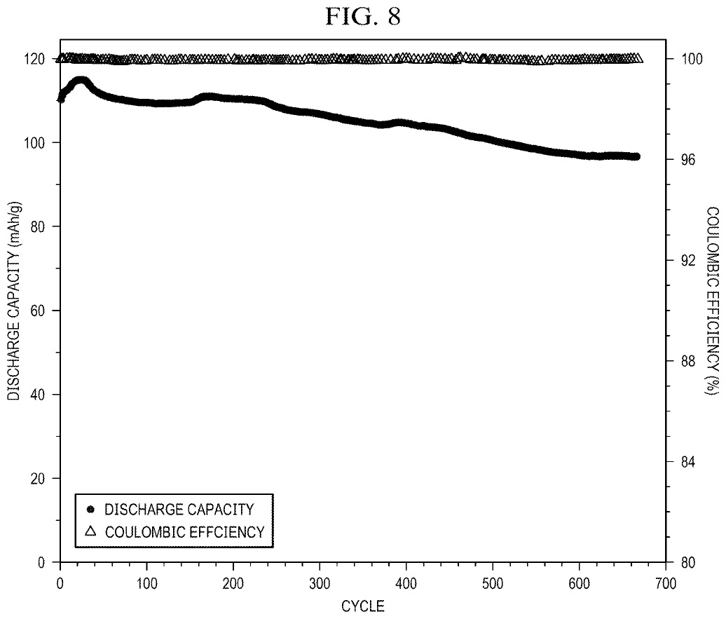

The engineered zinc-ion battery (ZIB) with a PANI-deposited cathode on a three-dimensional sponge-like carbon nanotube (CNT) structure demonstrates remarkable properties that are essential for stationary energy storage systems. FIG. 7D shows the comparison of total energy throughput for the highest performing cathodes currently known. The cycle life 5928 cycles at a practical current density of 0.2 A/g, demonstrates the practicality of the cell for stationary energy storage systems. FIG. 8 shows the cycling performance of a ZIB cell.

The scalability of the system is also proven by a large-scale beaker type cell that performs like the coin cell. Furthermore, a careful analysis of self-discharge behavior shows that, even after an extended period of rest, there is very little capacity loss—less than 10%—and that, after normal cycling, full capacity is restored. The exceptional performance can be attributed to the distinct features of the 3D CNT host, which provides a high porosity and elasticity to allow for significant volume changes during charge-discharge cycles. This helps to maintain structural integrity over time and reduce capacity fade. In addition, the addition of the DMSO additive also improves the stability of the system by modifying zinc solvation structure, effectively preventing dendrite formation, and reducing side reactions caused by water. These results highlight our ZIB configuration's enormous potential for stationary energy storage by highlighting its robustness, resilience, and suitability for practical implementation in stationary applications.

### WORKING EXAMPLES

Materials used are polyaniline (emeraldine base, Mw~50000; Sigma Aldrich); aniline (99+%; Alfa Aesar), hydrochloric acid (HCl, 36.5%-38.0%, ACS; Macron Fine Chemicals); graphite foil (≥99.8% metals basis, thickness 0.254 mm; Alfa Aesar); iron foil (iron ≥99.99% metals basis, thickness 0.1 mm; Alfa Aesar); deionized (DI) water (>18 MΩ cm⁻¹); Carbon steel shim (1008-1010 carbon steel, thickness: 0.001 or 0.005 inch; Precision Brand Products, Inc.).

For the sandwich-type cathode, the CNT sponge was sliced to ~100-micron thickness and pouched into ⅜ inch diameter. Then, PANI powder was put between two pieces of CNT sponge slices with the following pressing. For the cylinder cell test, the CNT sponge was cut into 1.5 cm height with original 2.1 cm diameter. PANI was synthesized in a CNT sponge by electrical deposition method that CNT sponge was immersed into aniline solution (0.1 M in 1 M HCl) with 10 mA DC supply for 3 hrs.

Full Fe-ion cells (2025 coin cells) were assembled with the sandwich-type cathode, circular carbon steel foil (diameter: ½ inch) as the anode, filter paper (diameter: ⅝ inch) separator, and saturated FeSO₄ solution in water as the electrolyte. 100 μL electrolyte was applied in the coin cell.

The cylinder cell was assembled with a cylinder-type cathode, carbon steel wire (diameter: 0.08 inch) as the anode, braided expandable sleeving as the separator, and saturated FeSO₄ solution in water as the electrolyte. Carbon steel wire with braided expandable sleeving insert through the center of the cylinder-type cathode, and then they were put in the 2-dram vial with following adding 4 mL electrolyte. For the sealing process, two holes (one for carbon steel wire anode and another one for cathode current collector) were prepared on a vial cap and silicone was applied to seal the gap.

Galvanostatic charge/discharge test for coin cells and cylinder cells was carried out by the Landt battery test system (Model: CT3002A). For cyclic voltammetry test, we used PANI electrode by electrical deposition method on CNT sponge as working electrode, platinum wire as counter electrode and standard Ag/AgCl electrode as reference electrode in 1M FeSO₄ solution.

The cylindrical CNT sponge is grown inside a 1-inch quartz tube (22 mm inner diameter) in a 3-zone tube furnace (Lindberg Blue M, Thermo Scientific) using chemical vapor deposition (CVD). 400 mg Ferrocene (Acros) was used as a catalyst for the CNT growth and was placed in zone 1. The tube was initially purged with Ar (Airgas, 99.999%) and then zone-1 and zone-3 were ramped up to 120 C and 650 C within 20, and 10 minutes respectively while flowing 260 sccm of H2 (Airgas, 99.999%). Following that, the CNT growth reaction was carried out by introducing 80 sccm of Ar, 80 sccm of C2H4 (Airgas, 99.999%), and 260 sccm of H2. Ar was supplied through a bubbler that enabled the flow of water vapor with Ar flow. Intertangled CNT was grown from the inner wall of the quartz tube and eventually fully blocked by the highly porous (98%) cylindrical CNT sponge within 30-minutes. After the reaction, the furnace was naturally cooled down to room temperature flowing Ae. The length of the sponge is about 10 cm. The CNT sponge is then cut into 100-micron thin slices using a blade and made into circular pieces 0.71 and 1 cm2 circular pieces. The circular sponge was then attached to graphite foil using carbon paint and used in a two-electrode setup for the electrodeposition of PANI. Graphite foil was used as the counter electrode. The deposition was done by the oxidation of Aniline (0.1 M in 1M HCl) with a constant current of 2 mA/cm2. The PANI-deposited CNT sponge was washed using DI water and dried in a vacuum oven at 60 C. The dried PANI-deposited CNT sponge was then used as the cathode.

The Zn-ion cell was assembled using CR2032 coin cell using zinc foil (200-microns) as the anode, PANI/CNT as the cathode, and Whatman qualitative filter paper, grade 1 as the separator. 2M ZnSO₄ with 20 wt % DMSO is used as electrolyte. The cycling test was carried out using Landt Instruments. The cells were cycled from 0.5V-1.5V at 0.1 A/g-2 A/g.

A short circuit test was performed in a transparent container with a dimension of 5.4 cm×5.4 cm×5.4 cm and a wall thickness of 2 mm. The CNT/PANI sandwich cathode was prepared by placing 4 mg of PANI in between two CNT sponges (1.5 cm diameter, 150 micron thick). The sandwich was then pressed gently by fingertips placed in between glass slides to bond the upper and lower sponges. The sandwich cathode was then attached to a graphite foil using carbon paint. After the carbon paint was fully dried, the cathode was placed inside the container through a slit created on the top of the container. A carbon steel anode was placed in a similar manner. The gap between the electrodes was ~8 mm. The electrolyte was then poured inside the container and then the container was purged with Argon. After purging, the container was sealed using silicone and the electrodes were connected on the battery tester. After seven regular discharge-charge cycles, one additional charge cycle followed by 20 seconds of rest. The anode was tilted towards the cathode to make the short circuit during that rest period. The electrodes were kept in the short circuit position for ~25 minutes. After the short circuit, the electrodes were again placed with ~8 mm gap in between and then cycled normally for eight more cycles.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded. #

[symbol]

What is claimed is:

1. A battery comprising:
an anode;
a cathode comprising a carbon nanotube with a polyaniline (PANI) deposition; and
an aqueous electrolyte solution.

2. The battery of claim 1, wherein the cathode comprises a sandwich-type cathode comprising carbon nanotubes sandwiching PANI.

3. The battery of claim 1, wherein the PANI deposition is on the surface of the cathode.

4. The battery of claim 1, wherein the anode is in the form of a foil or a wire.

5. The battery of claim 1, wherein the anode comprises at least one of carbon steel, iron, zinc, manganese, nickel, cobalt, vanadium or titanium.

6. The battery of claim 1, wherein the electrolyte solution comprises at least one of FeSO₄ or ZnSO₄.

7. The battery of claim 1, further comprising a separator.

8. The battery of claim 7, wherein the separator comprises a braided sleeve.

9. The battery of claim 8, wherein the braided sleeve comprises polyester.

10. The battery of claim 7, wherein the separator is a cellulose-based separator.

11. The battery of claim 1, wherein the battery has a cylindrical shape.

12. The battery of claim 1, wherein the battery has a prismatic shape.

13. The battery of claim 1, wherein the battery has a pouch shape.

14. The battery of claim 1, wherein the battery has a coin shape.

15. The battery of claim 1:
wherein the cathode comprises a carbon nanotube sponge with a PANI deposition;
wherein the anode comprises wire-type carbon steel;
wherein the electrolyte solution comprises FeSO₄; and
wherein the battery can operate more than 20,000 cycles and capacity retention is at least 84%.

16. The battery of claim 1:
wherein the cathode comprises a carbon nanotube sponge with a PANI deposition;
wherein the anode comprises zinc;
wherein the electrolyte solution comprises ZnSO₄; and
wherein the battery can operate more than more than 9,000 cycles and capacity retention is at least 70%.
